(19) United States
(12) Patent Application Publication
(10) Pub. No.: US 2025/0374408 A1
(43) Pub. Date: Dec. 4, 2025

(54) INFORMATION PROCESSING METHOD

(71) Applicant: SEIKO EPSON CORPORATION, Tokyo (JP)

(72) Inventors: Fumitaka KATO, MATSUMOTO-SHI (JP); Shinnosuke ARAKI, MATSUMOTO-SHI (JP)

(21) Appl. No.: 19/220,332

(22) Filed: May 28, 2025

(30) Foreign Application Priority Data
Jun. 4, 2024 (JP) 2024-090501

(51) Int. Cl. H05B 47/19; G06V 10/60

(52) U.S. Cl. CPC H05B 47/19; G06V 10/60

(57) ABSTRACT

An information processing method includes: transmitting, by an information terminal paired with each of a first device including a first light emitter and a second device including a second light emitter, first information for controlling driving of the first light emitter to the first device, based on first identification information related to the first device; executing, by the first device, first control for controlling the driving of the first light emitter, based on the first information; acquiring, by the information terminal, first image data representing an image including a first object and a second object, the first image data being an image of the first light emitter and the second light emitter picked up after the execution of the first control; and associating, by the information terminal, the first object with the first device, based on the first image data and the first information.

The present application is based on, and claims priority from JP Application Serial Number 2024-090501, filed Jun. 4, 2024, the disclosure of which is hereby incorporated by reference herein in its entirety.

### BACKGROUND

### 1. Technical Field

The present disclosure relates to an information processing method.

### 2. Related Art

According to the related art, a technique for operating a device such as an illumination device, using an information terminal such as a smartphone, is known. For example, JP-A-2018-98155 discloses a system that displays an image of a lighting fixture captured by a camera of a mobile terminal, on a touch panel of the mobile terminal, and performs lighting control of the lighting fixture, based on a touch operation on the touch panel. In the system described in JP-A-2018-98155, a target lighting fixture is specified by a touch operation using a lighting fixture position stored in a server.

JP-A-2018-98155 is an example of the related art.

In the system described in JP-A-2018-98155, since the lighting fixture position needs to be stored in the server, this places a heavy burden on the user. Also, when the lighting fixture is replaced, a plurality of lighting fixtures exist at the same lighting fixture position and consequently the target lighting fixture may not be able to be specified.

### SUMMARY

According to an aspect of the present disclosure, an information processing method includes: transmitting, by an information terminal paired with each of a first device including a first light emitter and a second device including a second light emitter, first information for controlling driving of the first light emitter to the first device, based on first identification information related to the first device; executing, by the first device, first control for controlling the driving of the first light emitter, based on the first information; acquiring, by the information terminal, first image data representing an image including a first object and a second object, the first image data being an image of the first light emitter and the second light emitter picked up after the execution of the first control; and associating, by the information terminal, the first object with the first device, based on the first image data and the first information.

### BRIEF DESCRIPTION OF THE DRAWINGS

FIG. 1 is a schematic diagram of a system used in an information processing method according to a first embodiment.

FIG. 2 is a configuration diagram of the system used in the information processing method according to the first embodiment.

FIG. 3 is a flowchart illustrating a flow of the information processing method according to the first embodiment.

FIG. 4 is a diagram illustrating an image represented by second image data.

FIG. 5 is a diagram illustrating an image represented by first image data.

FIG. 6 is a diagram illustrating an operation image.

FIG. 7 is a configuration diagram of a system used in an information processing method according to a second embodiment.

FIG. 8 is a flowchart illustrating a flow of an information processing method according to a third embodiment.

FIG. 9 is a configuration diagram of a system used in an information processing method according to a fourth embodiment.

FIG. 10 is a flowchart illustrating a flow of an information processing method according to the fourth embodiment.

### DESCRIPTION OF EMBODIMENTS

Preferred embodiments according to the present disclosure will be described below with reference to the accompanying drawings. Note that, in the drawings, the dimensions and scales of parts differ from the actual values as appropriate, and some of the parts are schematically shown to facilitate understanding. The scope of the present disclosure is not limited to the embodiments described below unless the description particularly states that limitations are applied to the present disclosure.

### 1. FIRST EMBODIMENT

### 1-1. Outline of System Used in Information Processing Method

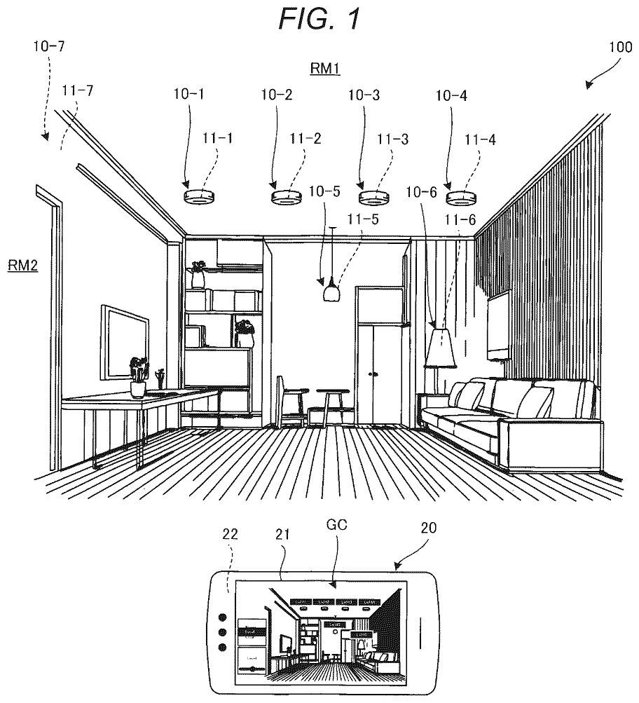

FIG. 1 is a schematic diagram of a system 100 used in an information processing method according to a first embodiment. The system 100 includes illumination devices 10-1 to 10-7 and an information terminal 20, and controls the driving of the illumination devices 10-1 to 10-7, using the information terminal 20. The illumination device 10-1 is an example of a “first device”. The illumination device 10-2 is an example of a “second device”. The illumination device 10-7 is an example of a “third device”.

Each of the illumination devices 10-1 to 10-7 is a lighting fixture. Each of the illumination devices 10-1 to 10-6 is installed in a room RM1. The illumination device 10-1 includes a light emitter 11-1 that emits light in the room RM1. The light emitter 11-1 is an example of a “first light emitter”. Similarly, the illumination devices 10-2 to 10-6 include light emitters 11-2 to 11-6 that emit light in the room RM1. The light emitter 11-2 is an example of a “second light emitter”. In contrast, the illumination device 10-7 is installed in a room RM2 different from the room RM1. The illumination device 10-7 includes a light emitter 11-7 that emits light in the room RM2. The light emitter 11-7 is an example of a “third light emitter”.

Hereinafter, the illumination devices 10-1 to 10-7 may be referred to as an illumination device 10 without being distinguished from each other. Also, the light emitters 11-1 to 11-7 may be referred to as a light emitter 11 without being distinguished from each other.

Note that the number of the illumination devices 10 installed in the room RM1 is not limited to the illustrated example and may be any number equal to or greater than two. The number of the illumination devices 10 installed in room RM2 is not limited to the illustrated example and may be any number. The illumination device 10 installed in the room RM2 may be omitted.

The information terminal 20 is an information processing device paired with each of the illumination devices 10-1 to 10-7, using a protocol such as Matter and has a function of controlling the operation of the illumination devices 10-1 to 10-7. “Matter” is a registered trademark. The information terminal 20 includes a display device 21 and causes the display device 21 to display an operation image GC for accepting an operation for controlling the operation of the illumination devices 10-1 to 10-7. The operation image GC includes an object OB associated with the illumination device 10 as described later. The information terminal 20 can execute processing of making this association. In the illustrated example, the information terminal 20 is a portable terminal such as a smartphone or a tablet terminal, and the display device 21 accepts a touch operation by the user on the operation image GC.

### 1-2. System Configuration Used in Information Processing Method

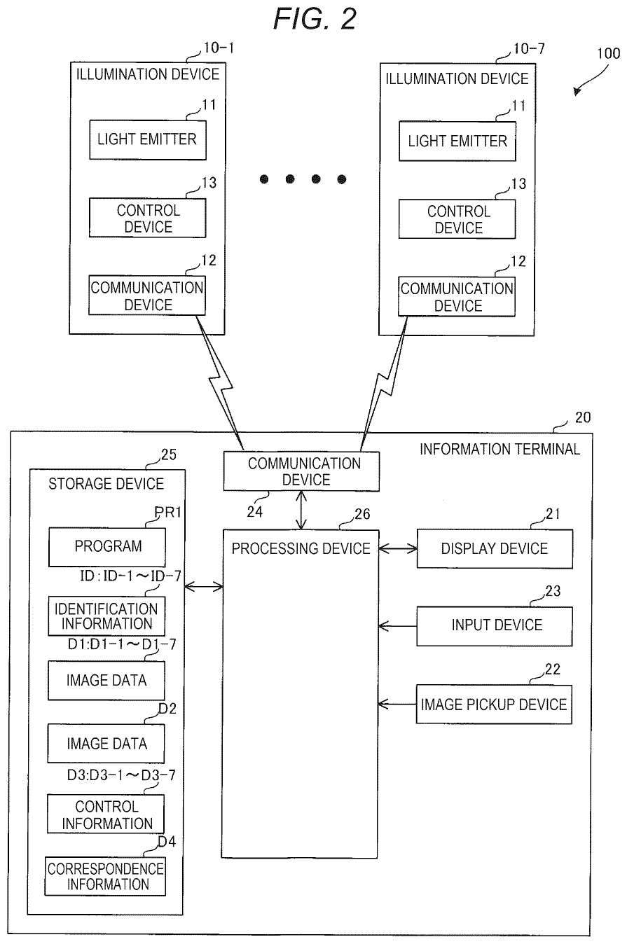

FIG. 2 is a configuration diagram of the system 100 used in the information processing method according to the first embodiment. As illustrated in FIG. 2, each of the illumination devices 10-1 to 10-7 includes the light emitter 11, a communication device 12, and control device 13.

The light emitter 11 is a light source that emits light when the electricity is on, and includes, for example, light emitting diode elements of a plurality of emission colors.

The communication device 12 is a receiving circuit that receives control information D3, described later, from the information terminal 20, and is, for example, a wireless communication device such as low power wide area (LPWA), wireless LAN including Wi-Fi, or Bluetooth. “Wi-Fi” and “Bluetooth” are registered trademarks.

The control device 13 is a circuit that controls the driving of the light emitter 11, based on the control information D3, described later. The control device 13 includes, for example, a power supply circuit including a converter or the like that converts power from an AC power supply, not illustrated, into DC and supplies the DC to the light emitter 11, and a control circuit including a processor or the like that controls an operation of the power supply circuit, based on the control information D3, described later.

The information terminal 20 includes the display device 21, an image pickup device 22, an input device 23, a communication device 24, a storage device 25, and a processing device 26. These devices are communicatively coupled to each other.

The display device 21 displays various images under the control by the processing device 26. The display device 21 is a display device including various display panels such as a liquid crystal display panel and an organic electro-luminescence (EL) display panel. The display device 21 in the present embodiment is a touch panel and also serves as the input device 23.

The image pickup device 22 is a digital camera including an image pickup element such as a charge-coupled device (CCD) or a complementary metal-oxide semiconductor (CMOS) device.

The input device 23 is input equipment that accepts an operation from the user. The input device 23 in the present embodiment is configured integrally with the display device 21 as a touch panel. The input device 23 is not limited to a touch panel and may be, for example, a touch pad provided separately from the display device 21 or a pointing device such as a mouse.

The communication device 24 is a communication device that can communicate with illumination devices 10-1 to 10-7 and the like. For example, the communication device 24 is a wireless communication device such as LPWA, a wireless LAN including Wi-Fi, or Bluetooth. The communication device 24 is not limited to a wireless communication device, and may be, for example, a wired communication device such as a wired local area network (LAN), a universal serial bus (USB), or a high-definition multimedia interface (HDMI).

The storage device 25 is a storage device that stores programs such as an operating system and application programs to be executed by the processing device 26 and data to be processed by the processing device 26. The storage device 25 includes, for example, a hard disk drive or a semiconductor memory. A part or the entirety of the storage device 25 may be an external storage device of the information terminal 20 or may be provided in an external device such as a server connected to the information terminal 20 via a communication network such as the Internet.

The storage device 25 stores a program PR1, identification information ID-1 to ID-7, image data D1-1 to D1-7, image data D2, control information D3-1 to D3-7, and correspondence information D4.

The identification information ID-1 is an example of “first identification information”. The identification information ID-2 is an example of “second identification information”. The identification information ID-7 is an example of “third identification information”. The image data D1-1 is an example of “first image data”. The image data D1-2 is an example of “fourth image data”. The image data D1-7 is an example of “fifth image data”. The image data D2 is an example of “second image data”. The control information D3-1 is an example of “first information”. The control information D3-2 is an example of “second information”. The control information D3-7 is an example of “third information”.

Hereinafter, the identification information ID-1 to ID-7 may be referred to as identification information ID without being distinguished from each other. The image data D1-1 to D1-7 may be referred to as image data D1 without being distinguished from each other. The control information D3-1 to D3-7 may be referred to as control information D3 without being distinguished from each other.

The program PR1 is a program for executing an information processing method, described later.

The identification information ID is information related to the illumination device 10, and is, for example, identification information for identifying the illumination device 10. Specifically, the identification information ID-1 is information related to the illumination device 10-1, and includes, for example, unique information of the illumination device 10-1. The identification information ID-2 is information related to the illumination device 10-2 and includes, for example, unique information of the illumination device 10-2. The identification information ID-3 is information related to the illumination device 10-3, and includes, for example, unique information of the illumination device 10-3. The identification information ID-4 is information related to the illumination device 10-4, and includes, for example, unique information of the illumination device 10-4. The identification information ID-5 is information related to the illumination device 10-5, and includes, for example, unique information of the illumination device 10-5. Identification information ID-6 is information related to the illumination device 10-6, and includes, for example, unique information of the illumination device 10-6. The identification information ID-7 is information related to the illumination device 10-7, and includes, for example, unique information of the illumination device 10-7.

The image data D1 is information representing an image G1, described later. The image G1 is an image of the light emitters 11-1 to 11-6 in the room RM1 picked up by the image pickup device 22 after the execution of step ST30, described later, and includes objects OB-1 to OB-6, described later. Specifically, the image G1 represented by the image data D1-1 is an image of the light emitters 11-1 to 11-6 picked up after the execution of the drive control of the light emitter 11-1 in step ST30. The image G1 represented by the image data D1-2 is an image of the light emitters 11-1 to 11-6 picked up after the execution of the drive control of the light emitter 11-2 in step ST30. The image G1 represented by the image data D1-3 is an image of the light emitters 11-1 to 11-6 picked up after the execution of the drive control of the light emitter 11-3 in step ST30. The image G1 represented by the image data D1-4 is an image of the light emitters 11-1 to 11-6 picked up after the execution of the drive control of the light emitter 11-4 in step ST30. The image G1 represented by the image data D1-5 is an image of the light emitters 11-1 to 11-6 picked up after the execution of the drive control of the light emitter 11-5 in step ST30. The image G1 represented by the image data D1-6 is an image of the light emitters 11-1 to 11-6 picked up after the execution of the drive control of the light emitter 11-6 in step ST30. The image G1 represented by the image data D1-7 is an image of the light emitters 11-1 to 11-6 picked up after the execution of the drive control of the light emitter 11-7 in step ST30.

The image data D2 is information representing an image G2, described later. The image G2 is an image of the light emitters 11-1 to 11-6 picked up before the execution of step ST30 described later, and includes the objects OB-1 to OB-6, described later.

The control information D3 is information for controlling the driving of the light emitter 11. Specifically, the control information D3-1 is information for controlling the driving of the light emitter 11-1. The control information D3-2 is information for controlling the driving of the light emitter 11-2. The control information D3-3 is information for controlling the driving of the light emitter 11-3. The control information D3-4 is information for controlling the driving of the light emitter 11-4. The control information D3-5 is information for controlling the driving of the light emitter 11-5. The control information D3-6 is information for controlling the driving of the light emitter 11-6. The control information D3-7 is information for controlling the driving of the light emitter 11-7.

The correspondence information D4 is information indicating the correspondence relationship between the illumination device 10 and the object OB, described later, and is obtained by associating the illumination device 10 with the object OB, described later, in the information processing method, described later.

The processing device 26 is a processing device having a function of controlling each part of the information terminal 20 and a function of processing various data. The processing device 26 includes, for example, a processor such as a CPU (central processing unit). Note that the processing device 26 may be configured with a single processor or a plurality of processors. A part or all of the functions of the processing device 26 may be implemented by hardware such as a digital signal processor (DSP), an application-specific integrated circuit (ASIC), a programmable logic device (PLD), or a field-programmable gate array (FPGA).

In the information terminal 20 described above, the processing device 26 executes the program PR1 stored in the storage device 25 and thus implements various functions necessary for the information processing method, described later.

### 1-3. Information Processing Method

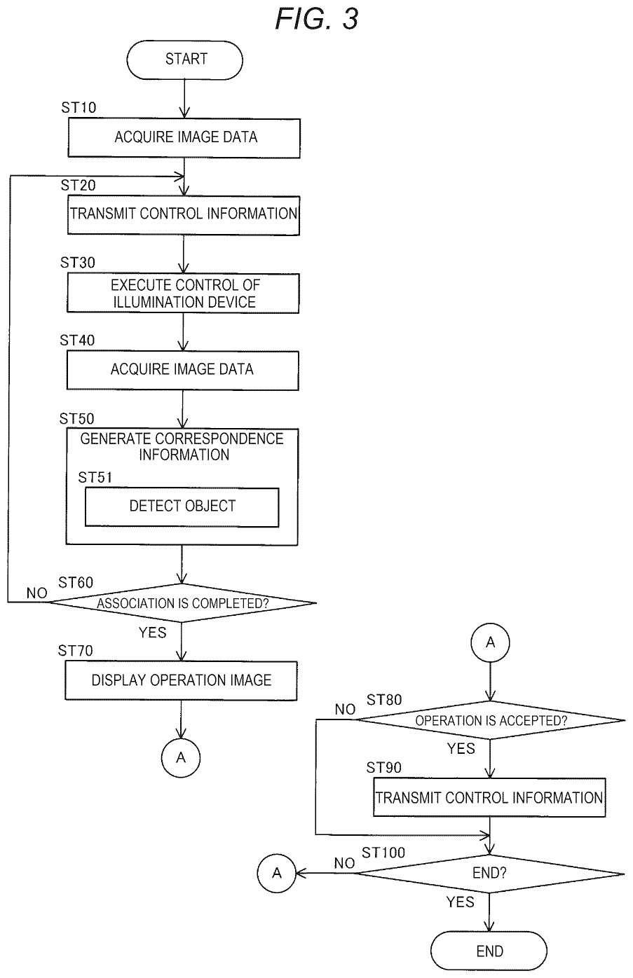

FIG. 3 is a flowchart illustrating a flow of the information processing method to the first embodiment. As shown in FIG. 3, the information processing method according to the present embodiment includes steps ST10 to ST100. In this example, steps ST20 to ST50 are repeated until the association between the illumination device 10 and the object OB, described later, is completed.

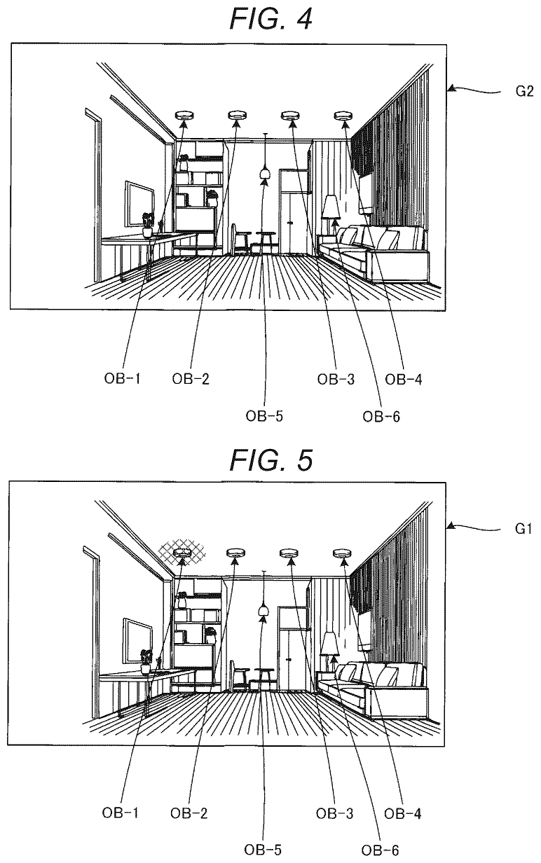

Specifically, first, in step ST10, the information terminal 20 acquires the image data D2. This acquisition is performed by the processing device 26 driving the image pickup device 22. At this point, it is preferable that all of the illumination devices 10-1 to 10-7 are off or that all of the illumination devices 10-1 to 10-7 are on. When all the illumination devices 10-1 to 10-7 are on, it is preferable that all the lighting colors are the same color. The image G2 represented by the image data D2 will be described later with reference to FIG. 4.

After step ST10, in step ST20, the information terminal 20 transmits the control information D3 to the illumination device 1 based on the identification information ID. As the execution of step ST20 is repeated, the control information D3-1 to D3-7 is sequentially transmitted. In the present embodiment, an example in which the transmission order of the control information D3-1 to D3-6 is the control information D3-1, D3-2, D3-3, D3-4, D3-5, and D3-6 is described. The control information D3-7 may be transmitted before or after the transmission of the control information D3-1 to D3-6, or may be transmitted during the transmission of the control information D3-1 to D3-6.

After step ST20, in step ST30, the illumination device 10 executes the drive control of the light emitter 11, based on the control information D3. As the execution of step ST30 is repeated due to the repetition of the execution of step ST20, the light emitters 11-1 to 11-7 are sequentially drive-controlled. The control in which the illumination device 10-1 controls the driving of the light emitter 11-1, based on the control information D3-1, is an example of “first control”. The control in which the illumination device 10-2 controls the driving of the light emitter 11-2, based on the control information D3-2, is an example of “second control”. The control in which the illumination device 10-7 controls the driving of the light emitter 11-7, based on the control information D3-7, is an example of “third control”.

The drive control of the light emitter 11 in step ST30 is control for setting the target light emitter 11 to a light-emitting state different from that of the other light emitters 11. Examples of the different light-emitting states include a state where the target light emitter 11 is made to emit light and the other light emitters 11 are turned off, a state where the target light emitter 11 is turned off and the other light emitters 11 are made to emit light, and a state where the light emission color of the target light emitter 11 is different from the light emission color of the other light emitters 11.

After step ST30, in step ST40, the information terminal 20 acquires the image data D1. This acquisition is performed by the processing device 26 driving the image pickup device 22. As the execution of step ST40 is repeated due to the repetition of the execution of step ST30, the image data D1-1 to D1-7 are sequentially acquired. The image G1 represented by the image data D1 will be described later with reference to FIG. 5.

After step ST40, in step ST50, the information terminal 20 associates the object OB, described later, with the illumination device 10, based on the image data D1 and the control information D3. Step ST50 includes step ST51. In step ST51, the information terminal 20 detects a change in the object OB due to the execution of step ST30, based on the image data D1 and the image data D2. The result of the detection is used to associate the object OB, described later, with the illumination device 10. This association will be described later with reference to FIGS. 4 and 5.

After step ST50, in step ST60, the information terminal 20 determines whether the association between the illumination device 10 and the object OB is completed. For example, when all the illumination devices 10-1 to 10-7 are associated with the object OB, the information terminal 20 determines that the association between the illumination device 10 and the object OB is completed. The information terminal 20 may determine that the association between the illumination device 10 and the object OB is completed, based on an operation from the user. The “operation from the user” refers to, for example, the user selecting a button (not illustrated): such as an “end association” button displayed on the display device 21.

When the association between the illumination device 10 and the object OB is not completed (NO in step ST60), the information terminal 20 returns to step ST20. Thus, the plurality of illumination devices 10 can be associated with the object OB.

As steps ST20 to ST50 are repeated in this manner, even when the plurality of light emitters 11 are controlled in the same manner, another object OB and the illumination device 10 can be associated with each other by processing separate from the association between a certain object OB and the illumination device 10. Therefore, the processing for these associations can be simplified.

However, when steps ST20 to ST50 are executed for the illumination device 10-7, the processing proceeds to step ST60 without associating the object OB with the illumination device 10 in step ST50.

Therefore, when the image G1 represented by the image data D1 does not include the object OB associated with the illumination device 10-7 and the image G1 represented by the image data D1 includes the object OB that is not associated with the illumination device 10 paired with the information terminal 20 (NO in step ST60), the information terminal 20 in step ST20 transmits, to another illumination device 10 paired with the information terminal 20, another control information D3 for controlling the driving of another light 11 emitter provided in the another illumination device 10, based on another identification information ID related to the another illumination device 10. Also, in step ST30, the another illumination device 10 executes another control for controlling the driving of the another light emitter 11, based on another identification information ID. Moreover, in step ST40, the information terminal 20 acquires another image data D1 representing the image G1 of the light emitters 11-1 to 11-6 picked up after the execution of the another control. In step ST50, the information terminal 20 associates another object OB included in the image G1 represented by the image data D1 with the another illumination device 10, based on the another image data D1 and the another control information D3. In this way, another object OB can be associated with another illumination device 10 after it is specified that the illumination device 10 that is not a target of association with the object OB is not present in the image pickup range.

Also, in step ST50, when there is one object OB left that is included in the image G1 represented by the image data D1 and is not associated with the illumination device 10 paired with the information terminal 20, the association between the remaining object OB and the illumination device 10 is clear and therefore the one object OB that is left and the illumination device 10 may be associated with each other without repeating steps ST20 to ST50. For example, after the object OB-1 and the illumination device 10-1 are associated with each other, when the remaining object OB is only the object OB-2, the object OB-2 and the illumination device 10-2 are associated with each other, based on the image data D1-1 and the control information D3-1. Thus, when there is no illumination device 10 to be associated with the object OB other than the illumination device 10-2, the object OB-2 and the illumination device 10-2 can be associated with each other without controlling the driving of the light emitter 11-2. As a result, the processes for the association can be reduced.

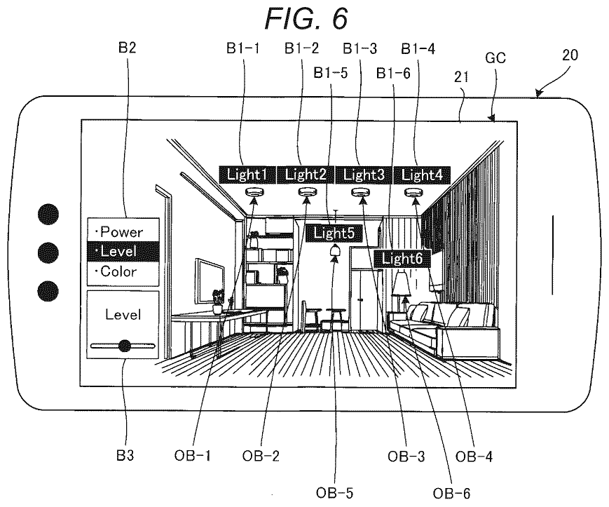

Meanwhile, when the association between the illumination device 10 and the object OB is completed (YES in step ST60), the information terminal 20 in step ST70 causes the display device 21 to display the operation image GC using the image G1 represented by the image data D1. A specific example of the operation image GC will be described later with reference to FIG. 6.

After step ST70, in step ST80, the information terminal 20 determines whether an operation of selecting the object OB using the operation image GC is accepted.

When the operation on the operation image GC is accepted (YES in step ST80), the information terminal 20 in step ST90 transmits the control information D3 for controlling the driving of the light emitter 11 corresponding to the operation, to the illumination device 10, based on the operation of selecting the object OB, and thus controls the driving of the light emitter 11.

After step ST90 or when the operation on the operation image GC is not accepted (NO in step ST80), the information terminal 20 in step ST100 determines whether to end the processing. This determination is made, for example, based on an operation from the user.

When the processing is not to be ended (NO in step ST100), the information terminal 20 returns to step ST80. Thus, the operation image GC can be displayed on the display device 21 until an operation on the operation image GC is accepted. Meanwhile, when the processing is to be ended (YES in step ST100), the information terminal 20 ends the processing.

FIG. 4 is a diagram illustrating the image G2 represented by the image data D2. FIG. 4 illustrates the image G2 represented by the image data D2 acquired by executing step ST10 in the state where all of the illumination devices 10-1 to 10-7 are off.

The image G2 is an image formed by picking up an image of the inside of the room RM1, and includes the objects OB-1 to OB-6. The object OB-1 is an example of a “first object”. The object OB-2 is an example of a “second object”.

The object OB-1 is a picked-up image of the illumination device 10-1. The object OB-2 is a picked-up image of the illumination device 10-2. The object OB-3 is a picked-up image of the illumination device 10-3. The object OB-4 is a picked-up image of the illumination device 10-4. The object OB-5 is a picked-up image of the illumination device 10-5. The object OB-6 is a picked-up image of the illumination device 10-6. Since the illumination device 10-7 is installed in the room RM2 different from the room RM1, the image G2 does not include a picked-up image of the illumination device 10-7.

FIG. 5 is a diagram illustrating the image G1 represented by the image data D1. FIG. 5 illustrates the image G1 represented by the image data D1-1 acquired by executing step ST40 after the drive control of the light emitter 11-1 is performed in step ST30 by transmitting the identification information ID-1 in step ST20.

In the example illustrated in FIG. 5, the image G2 is different from the image G1 only in the object OB-1, which is the picked-up image of the illumination device 10-1. Therefore, in step ST51, the object OB-1 can be detected based on the difference between the image G1 and the image G2, and the object OB-1 and the illumination device 10-1 can thus be associated with each other.

As described above, in step ST51, the information terminal 20 detects a change in the object OB due to the execution of step ST30, based on the image data D1 and the image data D2. Thus, the object OB and the illumination device 10 can be associated with each other, based on the difference between the image G1 represented by the image data D1 and the image G2 represented by the image data D2. Also, even when another illumination device 10 different from the target of the association executes processing similar to step ST30 before or after step ST30, the recognition of a wrong object OB is suppressed.

When the control in step ST30 controls the emission color of the target light emitter 11, the image data D1 is acquired in the state where the target light emitter 11 and another light emitter 11 are made to emit light in different colors in step ST40, and the target object OB and the target illumination device 10 can thus be associated with each other, based on the difference in color between the target object OB and another object OB included in the image G1 represented by the image data D1. When the another light emitter 11 and the another object OB are in one set, the another object OB and the another illumination device 10 can be associated with each other, based on the difference in color between the target object OB and the another object OB included in the image G1 represented by the image data D1. There is also an advantage in that the distinction between the target object OB and the another object OB included in the image G1 represented by the image data D1 is less likely to be affected by external light. Meanwhile, when the control in step ST30 is on-off control or brightness control and the image data D1 is acquired in the state where both the target light emitter 11 and the another light emitter 11 emit light, it may be difficult to distinguish the target object OB and the another object OB included in the image G1 represented by the image data D1, depending on the situation of external light or the like.

As described above, the information terminal 20 can recognize the objects OB-1 to OB-6 as the objects OB corresponding to the illumination devices 10-1 to 10-6, even without registering the information indicating the positions of the illumination devices 10-1 to 10-6 in the server or the like.

FIG. 6 is a diagram illustrating the operation image GC. The operation image GC includes buttons B1-1 to B1-6, B2, and B3, and the buttons B1-1 to B1-6, B2, and B3 are displayed as superimposed on the image G1 represented by the image data D1. Hereinafter, the buttons B1-1 to B1-6 may be referred to as a button B1 without being distinguished from each other.

The button B1 is a button for operating the illumination device 10 and can accept an operation of selecting the object OB. The button B1-1 is a button for operating the illumination device 10-1 and accepts an operation of selecting the object OB-1. The operation of selecting the object OB-1 is an example of a “first operation”. The button B1-2 is a button for operating the illumination device 10-2 and accepts an operation of selecting the object OB-2. The button B1-3 is a button for operating the illumination device 10-3 and accepts an operation of selecting the object OB-3. The button B1-4 is a button for operating the illumination device 10-4 and accepts an operation of selecting the object OB-4. The button B1-5 is a button for operating the illumination device 10-5 and accepts an operation of selecting the object OB-5. The button B1-6 is a button for operating the illumination device 10-6 and accepts an operation of selecting the object OB-6.

In this way, as the object OB to be displayed on the display device 21 is selected after the association between the object OB and the illumination device 10, the driving of the corresponding light emitter 11 can be controlled.

In the illustrated example, the button B1 is arranged in the operation image GC such that the distance between the center of the button B1 and the corresponding object OB is shorter than the distance between the center of the button B1 and the non-corresponding object OB. Thus, the correspondence relationship between the button B1, the object OB, and the illumination device 10 can be easily understood.

The button B2 is a button for selecting the control content of the illumination device 10 corresponding to the selected object OB. In the illustrated example, the button B2 includes an item “Power” for turning on and off the illumination device 10, an item “Level” for adjusting the light emission intensity of the illumination device 10, and an item “Color” for adjusting the light emission color of the illumination device 10. The display content of the button B2 is not limited to the illustrated example and may be freely set.

The button B3 is a button for changing the driving state of the illumination device 10 corresponding to the selected object OB. In the illustrated example, the button B3 includes an operable indication for the selection content of the button B2. The display content of the button B3 is not limited to the illustrated example and may be freely set.

As described above, in the present embodiment, the information terminal 20 can recognize the objects OB-1 to OB-6 as the objects OB corresponding to the illumination devices 10-1 to 10-6, even without registering the information indicating the positions of the illumination devices 10-1 to 10-6 in the server or the like. Thus, usability can be improved.

### 2. SECOND EMBODIMENT

A second embodiment of the present disclosure will be described below. In the embodiment described below, elements having effects and functions similar to those in the first embodiment are denoted by the same reference numerals used in the first embodiment, and the detailed description thereof will be omitted as appropriate.

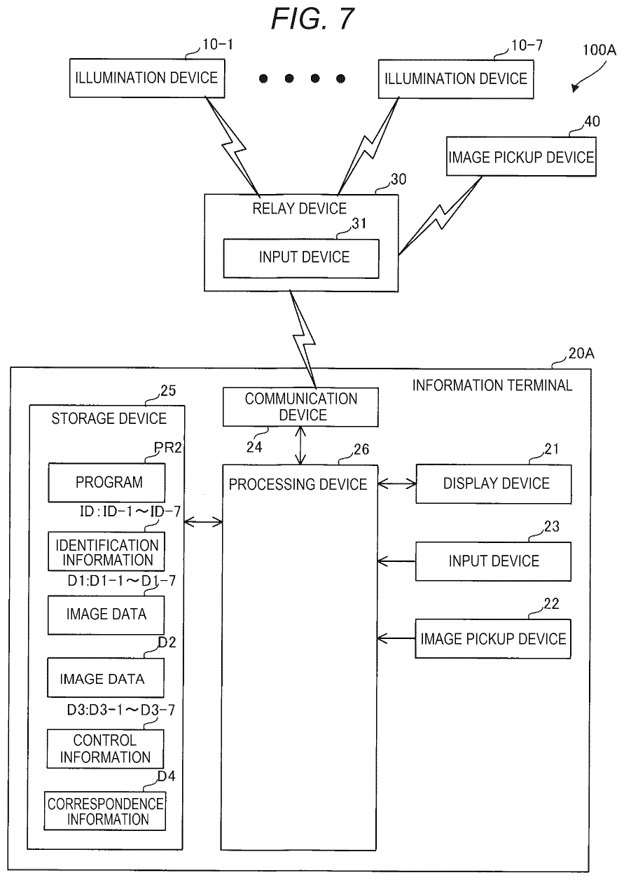

FIG. 7 is a configuration diagram of a system 100A used in the information processing method according to the second embodiment. The system 100A is configured similarly to the system 100 of the first embodiment except that an information terminal 20A is provided instead of the information terminal 20 and that a relay device 30 and an image pickup device 40 are added.

The information terminal 20A is configured similarly to the information terminal 20 of the first embodiment except that a program PR2 is used instead of the program PR1. In the information terminal 20A, the image pickup device 22 may be omitted.

The information terminal 20A performs operations similar to the operations of the information terminal 20 of the first embodiment except that the information terminal 20A transmits the control information D3 to the illumination devices 10-1 to 10-7 via the relay device 30 and acquires the image data D1 and D2, using the image pickup device 40 instead of the image pickup device 22.

The information terminal 20A is paired with each of the illumination devices 10-1 to 10-7 via the relay device 30, using a protocol such as Matter.

The relay device 30 is a control device such as an artificial intelligence (AI) speaker paired with the illumination devices 10-1 to 10-7, the information terminal 20A, and the image pickup device 40, using a protocol such as Matter, and is configured to control the driving of the illumination devices 10-1 to 10-7. In the illustrated example, the relay device 30 includes an input device 31 for voice recognition. Thus, the driving of the illumination devices 10-1 to 10-7 can be controlled by voice.

The image pickup device 40 is a digital camera such as a monitoring camera paired with the relay device 30, using a protocol such as Matter, and includes an image pickup element such as a CCD or a CMOS, and a communication circuit coupled to the image pickup element.

Usability can also be improved by the second embodiment described above.

### 3. THIRD EMBODIMENT

A third embodiment of the present disclosure will be described below. In the embodiment described below, elements having effects and functions similar to those in the first embodiment are denoted by the same reference numerals used in the first embodiment, and the detailed description thereof will be omitted as appropriate.

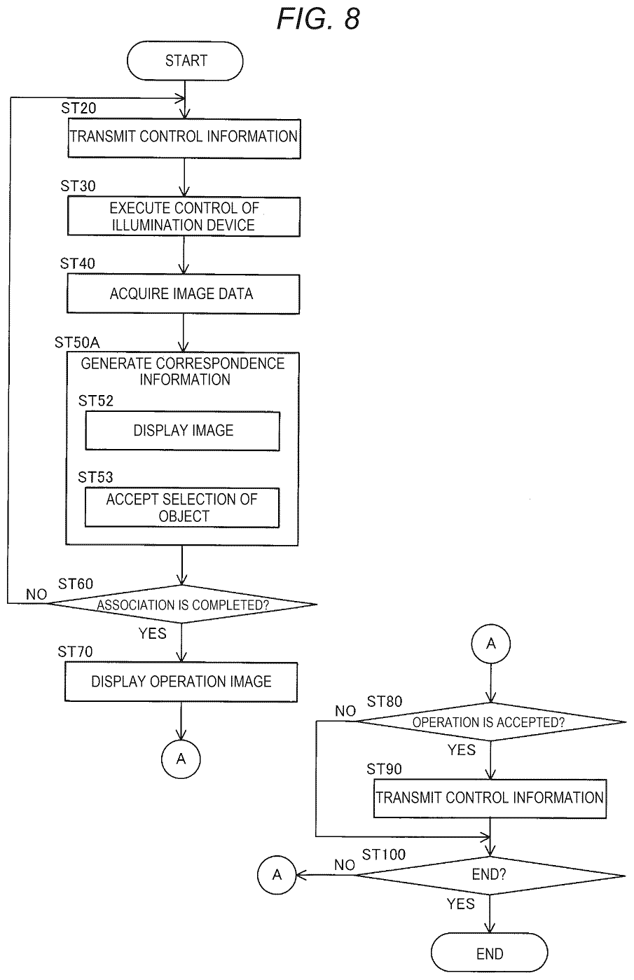

FIG. 8 is a flowchart illustrating a flow of the information processing method according to the third embodiment. The information processing method of the present embodiment is similar to the information processing method of the first embodiment except that step ST10 is omitted and that step ST50A is provided instead of step ST50.

Step ST50A includes steps ST52 and ST53. In step ST52, the information terminal 20 causes the display device 21 to display the image G1 represented by the image data D1. The image G1 enables the acceptance of an operation of designating a position in the image G1 on the display device 21.

After step ST52, in step ST53, the information terminal 20 accepts an operation of selecting the object OB in the image G1 displayed on the display device 21. The target object OB in the image G1 is visually different from the other objects OB due to the execution of step ST30. Therefore, the user can select the target object OB, based on this difference. The target object OB selected by the user may be information such as pixel coordinates in the image G1.

As described above, after the user visually recognizes the object OB displayed on the display device 21, the object OB and the illumination device 10 are associated with each other by the user's operation. Thus, the reliability of the association between the object OB and the illumination device 10 can be improved.

Usability can also be improved by the third embodiment described above.

### 4. FOURTH EMBODIMENT

A fourth embodiment of the present disclosure will be described below. In the embodiment described below, elements having effects and functions similar to those in the first embodiment are denoted by the same reference numerals used in the first embodiment, and the detailed description thereof will be omitted as appropriate.

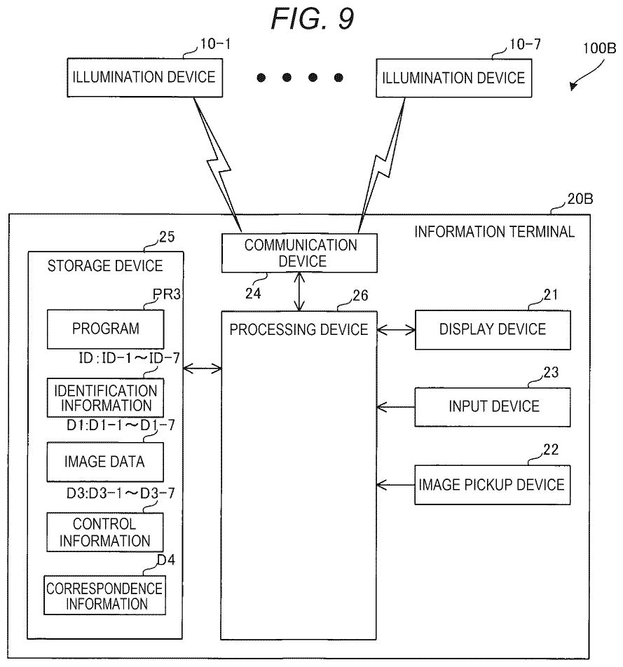

FIG. 9 is a configuration diagram of a system 100B used in the information processing method according to the fourth embodiment. The system 100B is configured similarly to the system 100 of the first embodiment except that an information terminal 20B is provided instead of the information terminal 20.

The information terminal 20B is configured similarly to the information terminal 20 of the first embodiment except that a program PR3 is used instead of the program PR1. The information terminal 20B executes operations similar to the operations of the information terminal 20 of the first embodiment except that the object OB and the illumination device 10 are associated with each other without using the image data D2. The image data D1-2 in the present embodiment is an example of “third image data”.

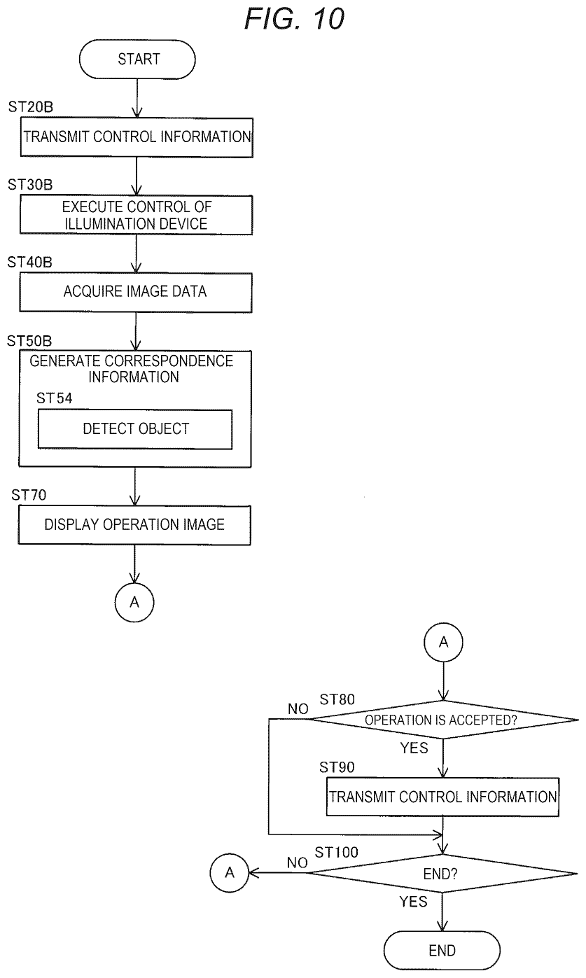

FIG. 10 is a flowchart illustrating a flow of the information processing method according to the fourth embodiment. The information processing method of the present embodiment is similar to the information processing method of the first embodiment except that steps ST10 and ST60 are omitted and that steps ST20B to ST50B are provided instead of steps ST20 to ST50.

In step ST20B, the information terminal 20B transmits the control information D3-1 to D3-7. The control information D3-1 to D3-7 indicates control of causing the light emitters 11-1 to 11-7 to flash on and off in a cyclic manner at predetermined time intervals and at timings shifted from each other.

After step ST20B, in step ST30B, the illumination device 10 executes the drive control of the light emitter 11, based on the control information D3. With the execution of step ST30B, the light emitters 11-1 to 11-7 flash on and off in a cyclic manner at predetermined time intervals and at timings shifted from each other.

After step ST30B, in step ST40B, the information terminal 20B acquires the image data D1 in a cyclic manner at predetermined time intervals. This cycle is an integral multiple of the cycle in step ST20B. Thus, the image data D1-1 to D1-7 can be acquired as in the first embodiment.

After step ST40B, in step ST50B, the information terminal 20B associates the object OB, described later, with the illumination device 10, based on the image data D1 and the control information D3. Step ST50B includes step ST54. In step ST54, the information terminal 20B detects a change in the object OB due to the execution of step ST30B, based on the image data D1-1 to D1-7. The result of the detection is used to associate the object OB, described later, with the illumination device 10.

In this way, in step ST40B, the information terminal 20B acquires another piece of image data D1 at a timing when a predetermined period elapses from the image pickup timing of one piece of image data D1. As described above, the control indicated by the control information D3 is control for controlling the flashing cycle of the light emitter 11. The predetermined period is an integral multiple of the cycle. In step ST54, the information terminal 20B detects a change in the object OB due to the execution of the control in step ST30B, based on the two pieces of image data D1 picked up at different image pickup timings. Thus, the object OB and the illumination device 10 can be associated with each other even when the emission colors of the light emitters 11-1 to 11-7 cannot be made different.

Usability can also be improved by the fourth embodiment described above.

### 5. MODIFICATION EXAMPLES

The embodiments described above by way of example can be modified in various manners. Specific aspects of modifications applicable to the embodiments described above will be described below by way of example. Two or more aspects freely selected from the examples below can be combined with each other as appropriate to the extent that no contradiction occurs.

### 5-1. Modification Example 1

In the above-described embodiments, an aspect in which the illumination devices 10-1 to 10-7 are used is described, but the present disclosure is not limited to this aspect, and for example, at least one of the illumination devices 10-3 to 10-7 may be omitted.

### 5-2. Modification Example 2

In the above-described embodiments, an aspect in which the device paired with the information terminal 20, 20A, or 20B is the illumination device 10 is described, but the present disclosure is not limited to this aspect, and various devices having the light emitter 11, instead of the illumination device 10, may be paired with the information terminal 20, 20A, or 20B.

### 6. APPENDICES

The present disclosure is summarized below as appendices.

(Appendix 1) According to a first aspect, which is a preferred example of the information processing method according to the present disclosure, an information processing method includes: transmitting, by an information terminal paired with each of a first device including a first light emitter and a second device including a second light emitter, first information for controlling driving of the first light emitter to the first device, based on first identification information related to the first device; executing, by the first device, first control for controlling the driving of the first light emitter, based on the first information; acquiring, by the information terminal, first image data representing an image including a first object and a second object, the first image data being an image of the first light emitter and the second light emitter picked up after the execution of the first control; and associating, by the information terminal, the first object with the first device, based on the first image data and the first information.

According to the above aspect, the first object can be recognized as an object corresponding to the first device at the information terminal even without registering the information indicating the positions of the first device and the second device in the server or the like.

(Appendix 2) According to a second aspect, which is a preferred example of the first aspect, the method further includes acquiring, by the information terminal, second image data representing an image of the first light emitter and the second light emitter picked up before the execution of the first control, and the associating the first object with the first device includes detecting, by the information terminal, a change in the first object due to the execution of the first control, based on the first image data and the second image data. According to the above aspect, the first object and the first device can be associated with each other, based on the difference between the image represented by the first image data and the image represented by the second image data. Also, even when another device executes processing similar to the first control before and after the first control, the recognition of a wrong object is suppressed.

(Appendix 3) According to a third aspect, which is a preferred example of the first aspect or the second aspect, the associating the first object with the first device includes: causing, by the information terminal, a display device to display an image represented by the first image data; and accepting, by the information terminal, an operation of selecting the first object displayed on the display device. According to the above aspect, since the association between the first object and the first device is made by the user's operation after the first object displayed on the display device is visually recognized by the user, the reliability of the association between the first object and the first device can be improved.

(Appendix 4) According to a fourth aspect, which is a preferred example of any one of the first to third aspects, the first control is to control a light emission color of the first light emitter. According to the above aspect, as the first image data is acquired in the state where the first light emitter and the second light emitter are made to emit light in colors different from each other, the first object and the first device can be associated with each other and the second object and the second device can be associated with each other, based on the difference in color between the first object and the second object included in the image represented by the first image data. There is also an advantage in that the distinction between the first object and the second object included in the image represented by the first image data is less likely to be affected by external light. Meanwhile, when the first control is on-off control or brightness control and the first image data is acquired in the state where both the first light emitter and the second light emitter emit light, it may be difficult to distinguish the first object and the second object included in the image represented by the first image data, depending on the situation of external light or the like.

(Appendix 5) According to a fifth aspect, which is a preferred example of any one of the first to fourth aspects, the method further includes acquiring, by the information terminal, third image data representing an image of the first light emitter and the second light emitter picked up at a timing when a predetermined period elapses from an image pickup timing of the first image data, the first control is to control a flashing cycle of the first light emitter, the predetermined period is a period that is an integral multiple of the cycle, and the associating the first object with the first device includes detecting, by the information terminal, a change in the first object due to the execution of the first control, based on the first image data and the third image data. According to the above aspect, even when the light emission colors of the first light emitter and the second light emitter cannot be made different, the first object and the first device can be associated with each other, and the second object and the second device can be associated with each other.

(Appendix 6) According to a sixth aspect, which is a preferred example of any one of the first aspect to the fifth aspect, the method further includes: transmitting, by the information terminal, second information for controlling driving of the second light emitter to the second device, based on second identification information related to the second device; executing, by the second device, second control for controlling the driving of the second light emitter, based on the second information; acquiring, by the information terminal, fourth image data representing an image of the first light emitter and the second light emitter picked up after the execution of the second control; and associating, by the information terminal, the second object with the second device, based on the fourth image data and the second information. According to the above aspect, even when the first control and the second control are the same control, the second object and the second device can be associated with each other by processing separate from the association between the first object and the first device. Therefore, the processing for these associations can be simplified.

(Appendix 7) According to a seventh aspect, which is a preferred example of any one of the first aspect to the sixth aspect, the information terminal is paired with a third device having a third light emitter, and the method further includes: transmitting, by the information terminal, third information for controlling driving of the third light emitter to the third device, based on third identification information related to the third device; executing, by the third device, third control for controlling the driving of the third light emitter, based on the third information; acquiring, by the information terminal, fifth image data representing an image of the first light emitter and the second light emitter picked up after the execution of the third control; transmitting, by the information terminal for another device paired with the information terminal, another information for controlling driving of another light emitter provided in the another device to the another device, based on another identification information related to the another device, when the image represented by the fifth image data does not include an object to be associated with the third device and the image represented by the first image data includes an object that is not associated with a device paired with the information terminal; executing, by the another device, another control for controlling the driving of the another light emitter, based on the another identification information; acquiring, by the information terminal, another image data representing an image of the first light emitter and the second light emitter picked up after the execution of the another control; and associating, by the information terminal, another object included in the image represented by the first image data with the another device, based on the another image data and the another information. According to the above aspect, another object and another device can be associated with each other after it is specified that the third device that is not a target of association with an object is not present within the image pickup range.

(Appendix 8) According to an eighth aspect, which is a preferred example of any one of the first aspect to the seventh aspect, the method further includes associating, by the information terminal, the second object with the second device, based on the first image data and the first information, when only the second object is an object included in the image represented by the first image data and not associated with a device paired with the information terminal. According to the above aspect, when there is no device to be associated with the object other than the second device, the second object and the second device can be associated with each other even without controlling the driving of the second light emitter. As a result, the processes for the association can be reduced.

(Appendix 9) According to a ninth aspect, which is a preferred example of any one of the first aspect to the eighth aspect, the method further includes: causing, by the information terminal, a display device to display an operation image using the image represented by the first image data; accepting, by the information terminal, a first operation of selecting the first object using the operation image; and transmitting the first information to the first device, based on the first operation, and thus controlling the driving of the first light emitter, by the information terminal. According to the above aspect, as the first object displayed on the display device is selected after the association between the first object and the first device, the driving of the first light emitter can be controlled.

What is claimed is:

1. An information processing method comprising:
transmitting, by an information terminal paired with each of a first device including a first light emitter and a second device including a second light emitter, first information for controlling driving of the first light emitter to the first device, based on first identification information related to the first device;
executing, by the first device, first control for controlling the driving of the first light emitter, based on the first information;
acquiring, by the information terminal, first image data representing an image including a first object and a second object, the first image data being an image of the first light emitter and the second light emitter picked up after the execution of the first control; and
associating, by the information terminal, the first object with the first device, based on the first image data and the first information.

2. The information processing method according to claim 1, further comprising:
acquiring, by the information terminal, second image data representing an image of the first light emitter and the second light emitter picked up before the execution of the first control, wherein
the associating the first object with the first device includes
detecting, by the information terminal, a change in the first object due to the execution of the first control, based on the first image data and the second image data.

3. The information processing method according to claim 1, wherein
the associating the first object with the first device includes:
causing, by the information terminal, a display device to display an image represented by the first image data; and
accepting, by the information terminal, an operation of selecting the first object displayed on the display device.

4. The information processing method according to claim 1, wherein
the first control is to control a light emission color of the first light emitter.

5. The information processing method according to claim 1, further comprising:
acquiring, by the information terminal, third image data representing an image of the first light emitter and the second light emitter picked up at a timing when a predetermined period elapses from an image pickup timing of the first image data, wherein
the first control is to control a flashing cycle of the first light emitter,
the predetermined period is a period that is an integral multiple of the cycle, and
the associating the first object with the first device includes
detecting, by the information terminal, a change in the first object due to the execution of the first control, based on the first image data and the third image data.

6. The information processing method according to claim 1, further comprising:
transmitting, by the information terminal, second information for controlling driving of the second light emitter to the second device, based on second identification information related to the second device;
executing, by the second device, second control for controlling the driving of the second light emitter, based on the second information;
acquiring, by the information terminal, fourth image data representing an image of the first light emitter and the second light emitter picked up after the execution of the second control; and
associating, by the information terminal, the second object with the second device, based on the fourth image data and the second information.

7. The information processing method according to claim 1, wherein
the information terminal is paired with a third device having a third light emitter, and
the information processing method further comprises:
transmitting, by the information terminal, third information for controlling driving of the third light emitter to the third device, based on third identification information related to the third device;
executing, by the third device, third control for controlling the driving of the third light emitter, based on the third information;
acquiring, by the information terminal, fifth image data representing an image of the first light emitter and the second light emitter picked up after the execution of the third control;
transmitting, by the information terminal for another device paired with the information terminal, another information for controlling driving of another light emitter provided in the another device to the another device, based on another identification information related to the another device, when the image represented by the fifth image data does not include an object to be associated with the third device and the image represented by the first image data includes an object that is not associated with a device paired with the information terminal;
executing, by the another device, another control for controlling the driving of the another light emitter, based on the another identification information;
acquiring, by the information terminal, another image data representing an image of the first light emitter and the second light emitter picked up after the execution of the another control; and
associating, by the information terminal, another object included in the image represented by the first image data with the another device, based on the another image data and the another information.

8. The information processing method according to claim 1, further comprising:
associating, by the information terminal, the second object with the second device, based on the first image data and the first information, when only the second object is an object included in the image represented by the first image data and not associated with a device paired with the information terminal.

9. The information processing method according to claim 1, further comprising:
causing, by the information terminal, a display device to display an operation image using the image represented by the first image data;
accepting, by the information terminal, a first operation of selecting the first object using the operation image; and
transmitting the first information to the first device, based on the first operation, and thus controlling the driving of the first light emitter, by the information terminal.
